(19) United States
(12) Patent Application Publication
(10) Pub. No.: US 2004/0074356 A1
(43) Pub. Date: Apr. 22, 2004

(54) Coil stock stress relief

(76) Inventor: Delno C. Abnet, Fort Wayne, IN (US)

Correspondence Address: BAKER & DANIELS, 111 E. WAYNE STREET, SUITE 800, FORT WAYNE, IN, 46802

(21) Appl. No.: 10/717,039

(22) Filed: Nov. 19, 2003

Related U.S. Application Data
(63) Continuation of application No. 07/697,444, filed on May 9, 1991.

(51) Int. Cl. B26D 3/00

(52) U.S. Cl. 83/55; 29/598; 83/41

(57) ABSTRACT

A process of, and apparatus for, the feeding of elongated strips of magnetic core stock material to successive stations of a multi-station die assembly for forming successive lamination blanks into individual magnetic core lamina is disclosed. To properly align the material with the corresponding dies, relative motion between each pair of successive lamination blanks is facilitated while those blanks are still joined. This relative motion is provided by significantly weakening the material in the region between two successive lamination blanks. In the illustrated preferred embodiment, the provision for relative motion includes removing the majority of the material interconnecting two adjacent lamination blanks without separating the individual lamination blanks from one another by use of an additional punch and die at the initial station for partially severing the strip between adjacent lamination blanks.

### SUMMARY OF THE INVENTION

The present invention relates generally to techniques for forming laminations for magnetic cores such as the magnetic cores (rotors and stators) typically found in dynamoelectric machines, and more particularly to a progressive die material alignment technique, that is, to a technique of facilitating material alignment at the successive stages in a progressive die assembly.

Progressive die assemblies for producing stator or rotor laminations are well known and described, for example, in U.S. Pat. No. 4,738,020. In these machines, a strip of lamination material is fed through a sequence of punching steps to progressively form it to the desired end configuration. Such strip material is never entirely uniform and this nonuniformity gives rise to problems of properly aligning the material for subsequent punching steps. For example, camber (a difference in lengths of the two edges of the strip) causes a partially formed blank to be presented to a subsequent stage somewhat laterally misplaced. Such problems are well known in the industry.

Among the several objects of the present invention may be noted the avoidance of the above-noted alignment problems; the relief of stress in coil stock material; the provision of a strip of progressively formed magnetic core laminations which readily aligns itself with a punch for each successive forming step; and the provision of a strip of lamination material which is more easily fed through a progressive forming die assembly than was heretofor possible. These as well as other objects and advantageous features of the present invention will be in part apparent and in part pointed out hereinafter.

In general, a multi-station die assembly for forming magnetic core laminations from sequential interconnected lamination blanks along an elongated strip of magnetic core stock material has an additional punch and die at the initial station for partially severing the strip between adjacent blanks so that adjacent blanks may be moved relative to one another to effect alignment of the blanks with the corresponding die while remaining connected to one another. Each station further forms a lamination blank as previously formed by action at the previous station as the material progresses from an initial station to a final station. The additional punch and die cut the material transverse to the direction of elongation while leaving at least one web portion between individual lamination blanks.

Also in general and in one form of the invention, a process of feeding an elongated strip of successive lamination blanks of magnetic core stock material to successive stations of a multi-station die assembly includes the provision for relative motion between each pair of successive lamination blanks while those blanks are still joined so that each lamination blank may properly align with a corresponding die. Such relative motion may be facilitated by significantly weakening the material in the region between two successive lamination blanks. In the preferred embodiment, this is accomplished by removing the majority of the material interconnecting two adjacent lamination blanks without separating the individual lamination blanks from one another.

### BRIEF DESCRIPTION OF THE DRAWING

FIG. 1 is a plan view of a portion of lamination strip material as modified according to the present inventive technique at successive stages of a die assembly;

FIG. 2a is an enlarged view of a portion of FIG. 1. showing the weakened region between two successive lamination blanks;

FIG. 2b is an enlarged view of the weakened region interconnecting two successive lamination blanks similar to FIG. 2a, but illustrating lamination blank alignment compensation;

FIG. 3 is an enlarged view of the weakened region interconnecting two successive lamination blanks similar to FIGS. 2a and 2b, but at a later stage in the process after removal of a portion of that region at a subsequent punching station;

FIG. 4 is a plan view of a small portion of a wide roll of lamination material illustrating the way in which several more narrow rolls, each for processing as in FIG. 1, are formed; and

FIG. 5 is a simplified vertical section of a progressive die assembly for producing laminations for dynamoelectric machine magnetic cores according to the-present invention in one form.

Corresponding reference characters indicate corresponding parts throughout the several views of the drawing.

The exemplifications set out herein illustrate a preferred embodiment of the invention in one form thereof and such exemplifications are not to be construed as limiting the scope of the disclosure or the scope of the invention in any manner.

### DESCRIPTION OF THE PREFERRED EMBODIMENT

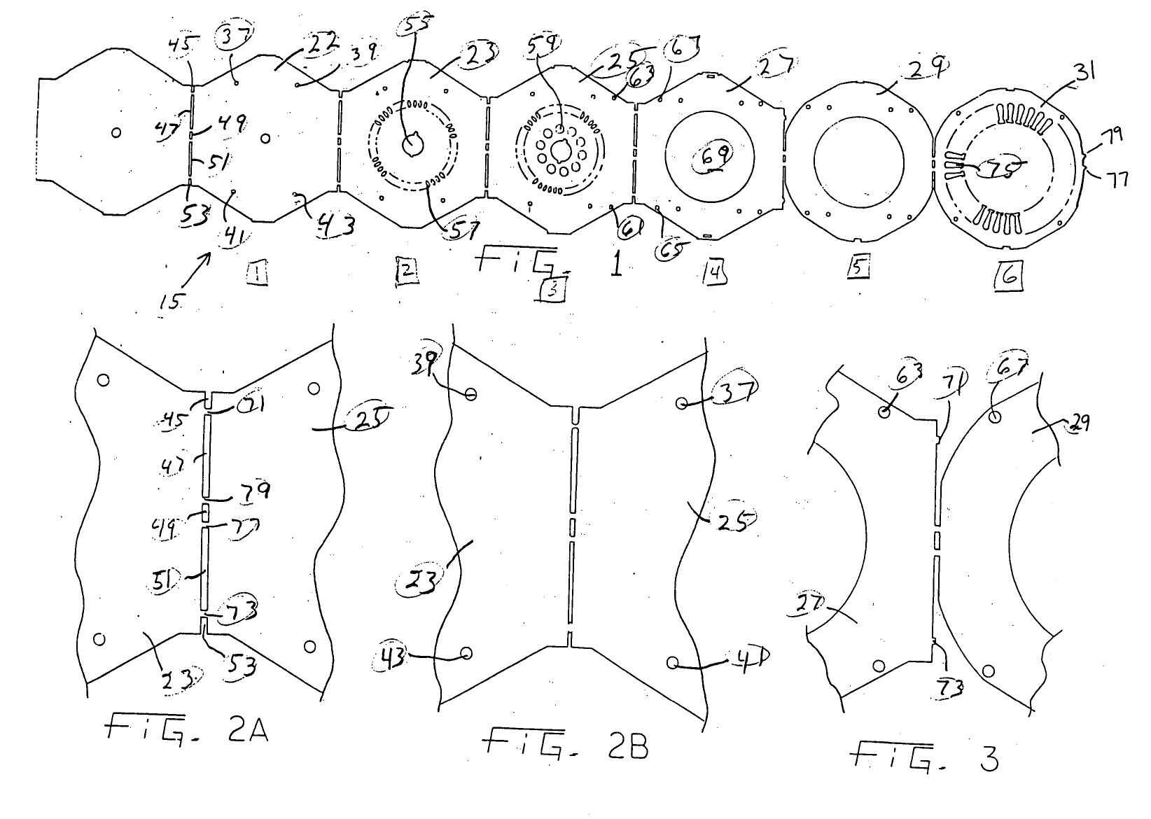

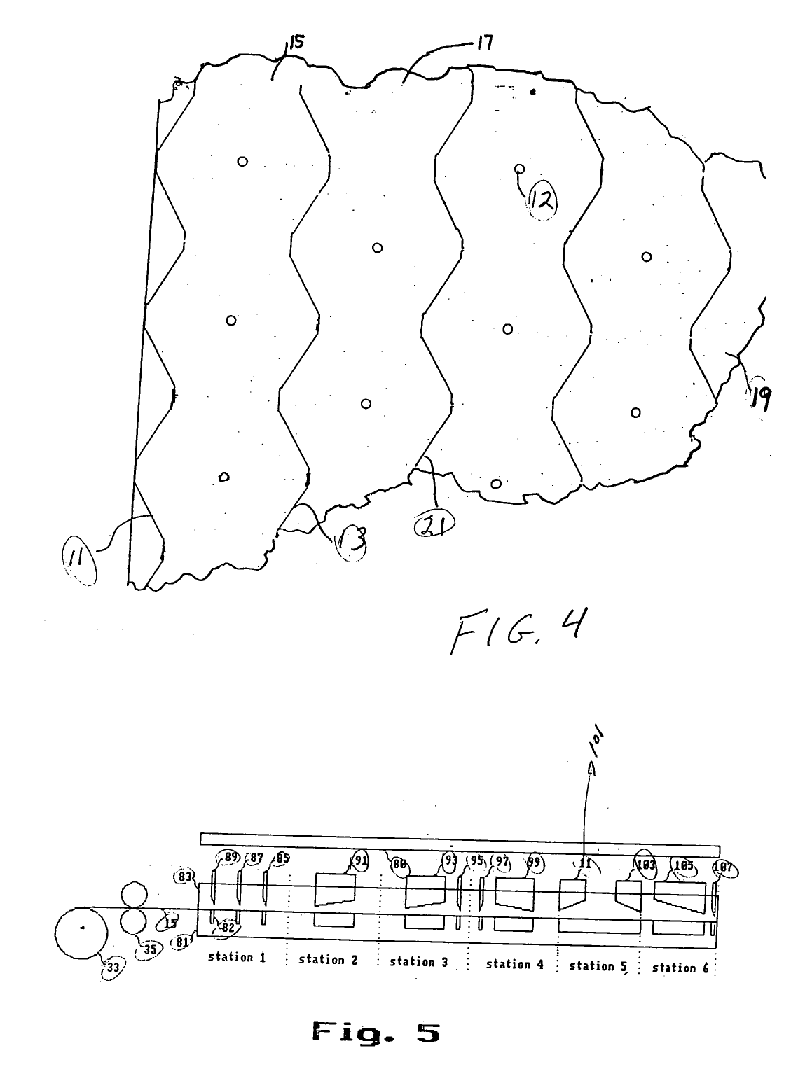

In the production of dynamoelectric machine stators and rotors, for example, a relatively wide strip of lamination material, an illustrative portion of which is shown in FIG. 4, may be cut lengthwise along the serpentine lines such as 11 and 13 in what is known as a scroll die and the central holes such as 12 may be formed at the same time. The several more narrow strips such as 15, 17 and 19 are then rewound for subsequent progressive die processing. Five such more narrow rolls are illustrated, but more may be formed depending on the particular application. Those strips (15 and 19) which were formed from the outermost portions of the original wide strip are frequently subject to greater variations in straightness than can be tolerated by the subsequent processing machinery. A typical problem, but not the only one, is camber where one edge of the narrow strip is slightly longer than the other edge. Another illustrative problem is that the cutter which forms one strip edge, say 21 for example, may be more dull that the cutter which forms the other side 13 of the narrow strip 17 and this can introduce camber or other feed problem producing variations in the narrow strips. Each such narrow strip such as 15, 17 and 19 is typically re-rolled and subsequently sequentially processed, for example, by a progressive or multi-station die assembly as illustrated in FIG. 5. Such a progressive die assembly requires that each of several connected blanks, 22-31 of FIG. 1, be simultaneously properly aligned with its corresponding punch and die. If one or more of the blanks is not properly aligned with the corresponding die, scrap metal rather than magnetic core laminations is produced. Whatever the cause, alignment problems in feeding the narrow strip material through such progressive die assemblies continue to plague the industry.

Comparing FIGS. 1 and 5, the edge of an illustrative lamination material strip 15 is seen in FIG. 5 and that strip passes from reel 33, between a thickness gauge and/or straightening rollers indicated generally at 35, and then into the first die assembly station. The strip 15 passes between a lower die portion 81 which has cut away regions 82 for receiving each of the punches conventionally supported within upper die portion 83. At station 1, the four alignment holes 37-43 and the slits 45-53 are punched from blank 22 by sets of punches 85 and 87, and 89 respectively. At station 2, a rotor arbor or shaft opening 55 as well as rotor conductor receiving slots 57 are punched in blank 23 by punch 91. The alignment holes 37-43 are utilized at each of the stations 2 through 5 for aligning the blank with the corresponding punch and die set. Slits 45-53 are one way to weaken the connecting material between two adjacent lamination blanks, say 23 and 25, for example, as will be discussed in greater detail subsequently. At station 3, vent holes 59 are formed by punch 93 and the bolt holes 61 and 63 are formed by a pair of punches 95 in blank 25. At station 4, two additional bolt holes 65 and 67 are punched by 97 and the rotor lamination is removed from the central portion 69 of the blank 27 by a further punch 99. The peripheral shape of the stator is imparted to blank 29 at station 5 by the punches 101 and 103 resulting in the severing of the outer webs 71 and 73 as best seen in FIG. 3. Conductor receiving stator slots 75 are punched by 105 in blank 31 at station 6 and the previous stator lamination (not shown) is severed, by cut-off punch 107, from the strip 15 by cutting the webs 77 and 79 and stacked for subsequent processing as more completely described in the above mentioned U.S. Pat. No. 4,738,020. The ram 80 actuates all six punch and die sets simultaneously to perform all six operations. The strip is then advanced by one blank and all six operations are performed on the next subsequent blank. This process repeats in a manner well known in the art.

FIGS. 2a and 2b show portions of the blanks 23 and 25 which are presented to stations 2 and 3 respectively. If the strip material is misaligned relative to these two stations, station 3 picks up the four alignment holes including 37 and 41 while station 2 picks up the adjacent four alignment holes including 39 and 43. Blank 25 moves relative to blank 23 by, for example, web 73 being compressed and web 71 being stretched, compare FIGS. 2a and 2b. Webs 77 and 79 experience similar, but less severe deformation. This same process may, of course, occur between any two stations. The relieved portions or slits 45-53 allow far greater relative movement between adjacent stator blanks than was heretofor possible. This weakening of the strip and corresponding increased relative mobility of adjacent blanks can, of course, be achieved in a number of different ways. A series of holes or perforations may replace the slits giving rise to a large number of webs. The junction between adjacent blanks could be creased so as to decrease its thickness without forming any complete openings. These are merely two examples and others will readily suggest themselves once the principle of the present invention is understood.

From the foregoing, it is now apparent that a novel technique for maintaining material alignment at successive stages of a progressive die arrangement as well as a novel coil stock stress relief feature have been disclosed meeting the objects and advantageous features set out hereinbefore as well as others, and that numerous modifications as to the precise shapes, configurations and details may be made by those having ordinary skill in the art without departing from the spirit of the invention or the scope thereof as set out by the claims which follow.

What is claimed is:

1. In a multi-station die assembly for forming magnetic core nations from sequential interconnected lamination blanks along an elongated strip of magnetic core stock material with each station further forming a lamination blank as previously formed by action at the previous stations as the material progresses from an initial station to a final station, the improvement comprising an additional punch and die at the initial station for partially severing the strip between adjacent blanks whereby adjacent blanks may be moved relative to one another to effect alignment of the blanks with the corresponding die while remaining connected to one another.

2. The improvement of claim 1 wherein the additional punch and die cut the material transverse to the direction of elongation while leaving at least one web portion between individual lamination blanks.

3. The process of feeding an elongated strip of successive lamination blanks of magnetic core stock material to successive stations of a multi-station die assembly including providing for relative motion between each pair of successive lamination blanks while those blanks are still joined so that each lamination blank may properly align with a corresponding die.

4. The process of claim 3 wherein the step of providing for relative motion includes significantly weakening the material in the region between two successive lamination blanks.

5. The process of claim 3 wherein the step of providing for relative motion includes removing the majority of the material interconnecting two adjacent lamination blanks without separating the individual lamination blanks from one another.

6. The process of feeding an elongated strip of successive lamination blanks of magnetic core stock material to successive stations of a multi-station die assembly to be sequentially transformed into individual laminations including significantly weakening the material in the region between each pair of successive lamination blanks while those blanks are still joined so that each lamination blank may properly align with a corresponding die.

7. The process of claim 6 wherein the step of weakening includes removing the majority of the material interconnecting two adjacent lamination blanks without separating the individual lamination blanks from one another.
